(19) United States
(12) Patent Application Publication
(10) Pub. No.: US 2022/0314485 A1
(43) Pub. Date: Oct. 6, 2022

(54) SYSTEM FOR FILLING VOIDS IN GLUED-IN-ROD STRUCTURES

(71) Applicant: Simpson Strong-Tie Company Inc., Pleasanton, CA (US)

(72) Inventors: Steven E. Pryor, Dublin, CA (US); Emory L. Montague, Pleasanton, CA (US); Guy T. Anderson, Valley Springs, CA (US); Quentin Hibben, Pleasanton, CA (US); Corey Clark, Bethpage, TN (US); Marlou Rodriguez, Pleasanton, CA (US); Randy Daudet, Pleasanton, CA (US); Robert Leichti, Pleasanton, CA (US); Paul McEntee, Fremont, CA (US)

(73) Assignee: Simpson Strong-Tie Company Inc., Pleasanton, CA (US)

(21) Appl. No.: 17/711,466

(22) Filed: Apr. 1, 2022

Related U.S. Application Data
(60) Provisional application No. 63/169,726, filed on Apr. 1, 2021.

(51) Int. Cl. B27M 1/08; B27G 11/00

(52) U.S. Cl. CPC B27M 1/08; B27G 11/00

(57) ABSTRACT

A glued-in-rod wooden structure includes a prepared hole for sealing voids which may be open to the prepared hole. In one example, the prepared hole is filled with an expanding foam which at least partially fills and seals the voids open to the prepared hole. Thereafter, the prepared hole may be enlarged by drilling to its final diameter for receiving the rod. Any voids in the enlarged hole remain sealed by the expanding foam.

### CLAIM OF PRIORITY

The present application claims priority to U.S. Provisional Patent Application No. 63/169,726, entitled “System for Filling Voids in Glued-In-Rod Structures,” filed Apr. 1, 2021, which application is incorporated in its entirety herein by reference.

### BACKGROUND

Glued-In-Rod (GIR) systems are known where a rod is glued into a hole that is drilled in wood. This wood may be solid sawn or composed of a structural composite lumber (SCL), such as for example cross laminated timber (CLT). In GIR, when glue is injected into the drilled hole to hold the rod in, the glue leaks into voids in the wood around the drilled hole. The leakage of glue prevents enough glue at the interface between the wood and rod for a secure bond.

### BRIEF DESCRIPTION OF THE DRAWINGS

FIG. 1 is a front cross-sectional view of a section of lumber such as cross laminated timber including rods glued in according to embodiments of the present technology.

FIGS. 2-6 show an enlarged front cross-sectional view of a section of lumber such as cross laminated timber including rods glued in according to a first embodiment of the present technology.

FIGS. 7-9 show an enlarged front cross-sectional view of a section of lumber such as cross laminated timber including rods glued in according to a second embodiment of the present technology.

FIGS. 10-11 show cross-sectional side and cross-sectional top views, respectively of a collar for centering the rod within the prepared hole according to embodiments of the present technology.

FIGS. 12-13 show cross-sectional side and cross-sectional top views, respectively of a helix for centering the rod within the prepared hole according to embodiments of the present technology.

### DETAILED DESCRIPTION

The present technology, roughly described, relates to systems and methods for filling voids around a drilled hole in glued-in-rod (GIR) structures. In wood structures, such as natural or engineered lumber, the wood may have voids. In natural lumber, the voids may exist in the grain of the wood. In engineered lumber, such as cross laminated timber, the voids may exist in the grain of the wood and/or where the pieces of timber are affixed to each other. In accordance with the present technology, before gluing a rod into a drilled hole, a prepared hole may be provided which prevents glue within the prepared hole from leaking into voids that would otherwise be in communication with the hole along the length of the hole. In embodiments that follow, the wood shown is cross laminated timber (CLT). However, it is understood that the following embodiments for filling voids in GIR structures may be formed of any type of wood or lumber.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

The terms “top” and “bottom,” “upper” and “lower” and “vertical” and “horizontal” as may be used herein are by way of example and illustrative purposes only, and are not meant to limit the description of the invention inasmuch as the referenced item can be exchanged in position and orientation. Also, as used herein, the terms “substantially” and/or “about” mean that the specified dimension or parameter may be varied within an acceptable manufacturing tolerance for a given application. In one embodiment, the acceptable manufacturing tolerance is ±2.5%.

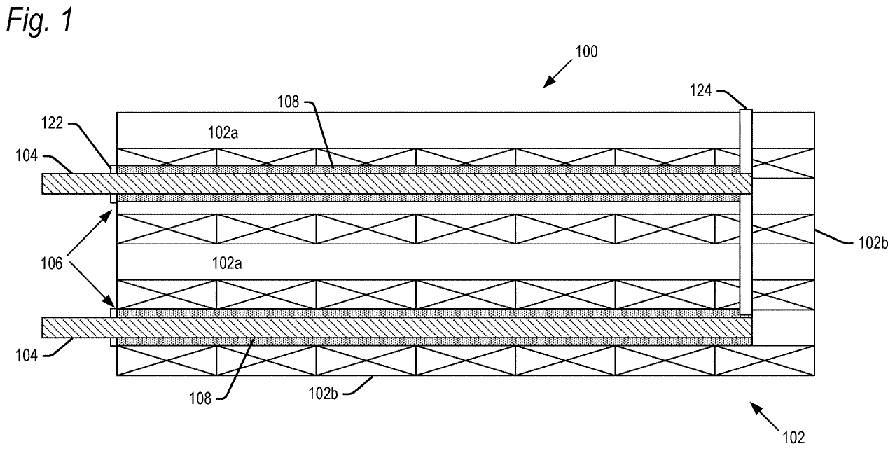

Referring initially to FIG. 1, there is shown a front cross-sectional view of a GIR structure 100 comprised of wood 102 in which rods 104 have been glued into drilled holes 106 using an adhesive 108. As noted, in the illustrated embodiments, the wood 102 may be CLT, including layers 102a of planks affixed together and extending in a first direction (left to right in FIG. 1), and layers 102b of planks affixed together and extending in a second direction (into the page of FIG. 1). There may be multiple layers 102a and 102b interspersed with each other. The number of layers, the directionality of each layer and the number of planks in each layer, are shown by way of example only and each may vary in further embodiments. The number of rods 104 is also shown by way of example and may vary in further embodiments.

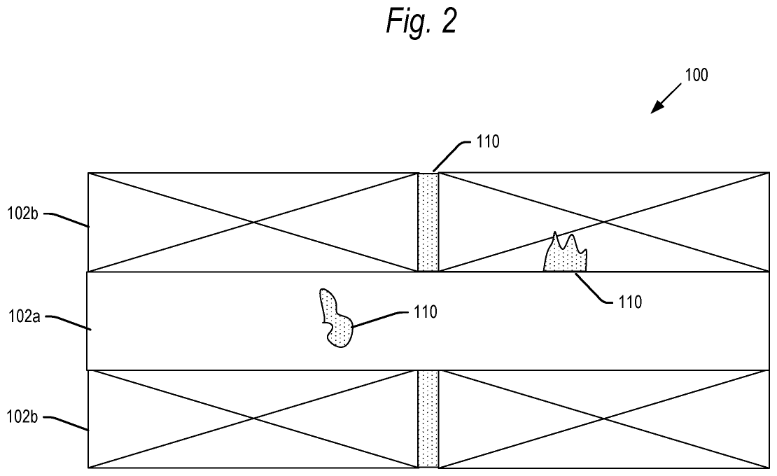

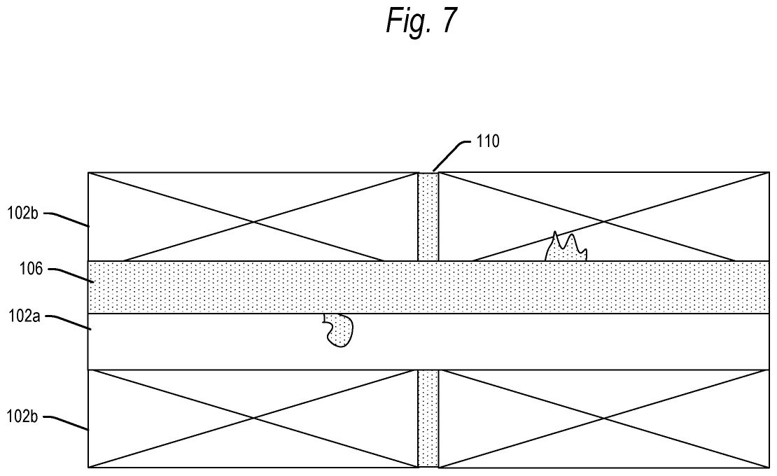

A first system and process for gluing in rods 104 in such a way as to prevent leakage of the glue into voids along the length of the drilled holes 106 will be explained with reference to FIGS. 2-6. A second system and process for gluing in rods 104 in such a way as to prevent leakage of the glue into voids along the length of the drilled holes 106 will be explained with reference to FIGS. 7-9.

Referring initially to FIGS. 2-6, FIG. 2 shows an enlarged section of the GIR structure 100 showing a portion of a layer 102a sandwiched between a portion of a pair of layers 102b. The wood 102 may include voids 110. These voids may be naturally occurring in the layers 102a, 102b and/or may occur where planks in a layer are affixed to each other. The number, type and appearance of the voids 110 is shown by example and will vary in different embodiments.

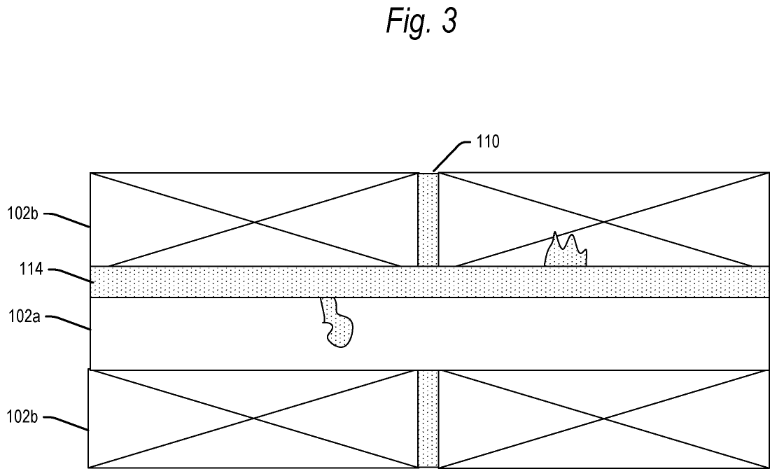

In accordance with the first embodiment, an intermediate hole 114 (also referred to herein as a prepared hole) may be drilled through the wood 102 as shown in FIG. 3. Although FIG. 3 shows only a portion of wood structure 102, the intermediate holes 114 may be drilled along the full length of the final drilled holes 106. Intermediate holes 114 may have a diameter that is smaller than the final drilled holes 106 as explained below. In embodiments, the diameter of the intermediate holes may be ⅛^{th} to ¼^{th} inches smaller than final drilled holes 106, though the intermediate holes may be comparatively smaller or larger in further embodiments. As shown, the intermediate holes 114 may be in communication to one or more of the voids 110. That is, when the intermediate holes 114 are drilled, one or more of the voids 110 may connect with the holes 114 along the length of the holes 114.

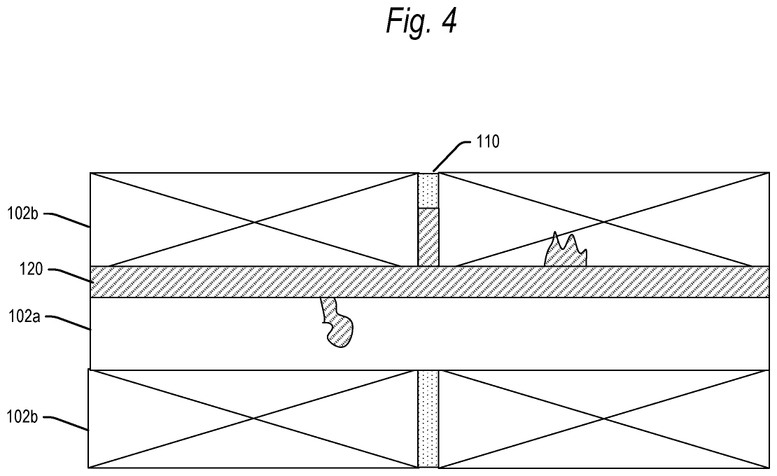

Referring now to FIG. 4, an expanding foam 120 may be injected into the intermediate holes 114. Various expanding foams may be used, but in one example, the expanding foam may be Crack-Pac Flex H₂O from Simpson Strong-Tie, headquartered in Pleasanton, Calif. Expanding foam 120 may be injected by various methods. For example, an end cap 122 (FIG. 1) may be inserted into a first end of each hole 114. The cap has an opening through which a tube (not shown) may be inserted fully into the intermediate holes. Thereafter, the expanding foam 120 may be injected through the tube as the tube is withdrawn from the intermediate holes 114, thereby depositing the foam along the length of the holes. In a further example, the tube may be omitted and the expanding foam 120 may be injected at the end cap 122. The cap 122 prevents foam from escaping from the end of holes 114. In another example the cap 122 may be omitted entirely.

The expanding foam 120 may be injected uniformly throughout the intermediate holes 114, and the expanding foam 120 may fill, or partially fill, the voids 110 in communication with intermediate holes 114. The foam may seep into the voids 110 by the injection force and/or upon expansion. After the foam fills the intermediate holes and voids 110, it may be cured or otherwise set.

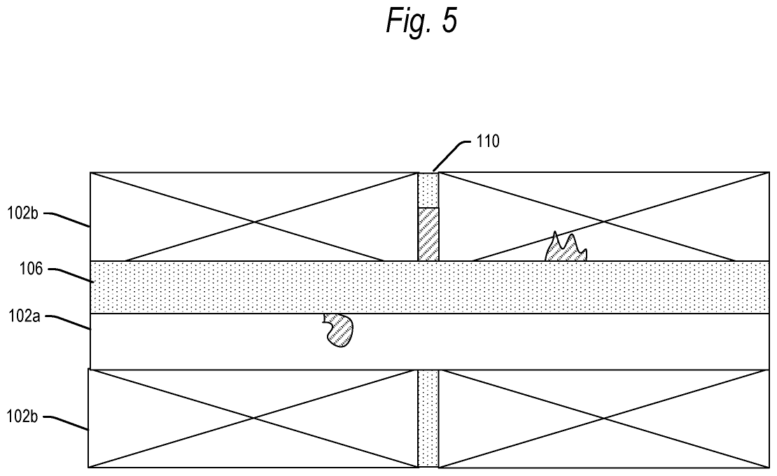

Referring now to FIG. 5, the final holes 106 may then be drilled through the wood 102. The final holes 106 are concentric with intermediate holes 114, in effect enlarging holes 114 to expose fresh wood fiber along the length of holes 106. The drilling of holes 106 removes the expanding foam 120 from within the drilled holes 106, but leaves an amount of the expanding foam 120 in the voids 110 connecting with drilled holes 106, effectively sealing off the voids 110 from drilled holes 106.

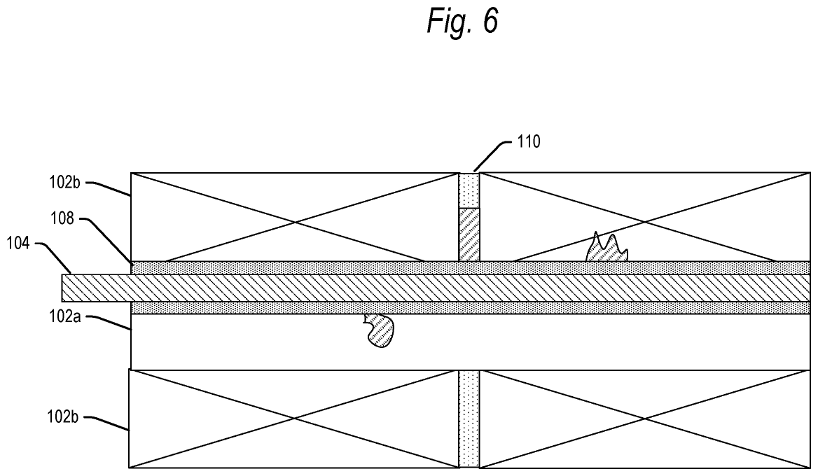

Next, the rods 104 with adhesive glue 108 may be inserted into holes 106 as shown in FIG. 6. The adhesive contacts the fresh wood fibers and rod along the length of holes 106 at all locations save at voids 110, effectively binding the rod 104 within the drilled holes 106. To facilitate filling of the space between the rod 104 and the hole 106 the adhesive 108 may be introduced into hole 106 through an air hole 124 (FIG. 1). Additional air holes 124 (not shown) may be placed at intervals along the hole 106 to allow air to escape while the adhesive 108 fills the space between the rod 104 and the hole 106.

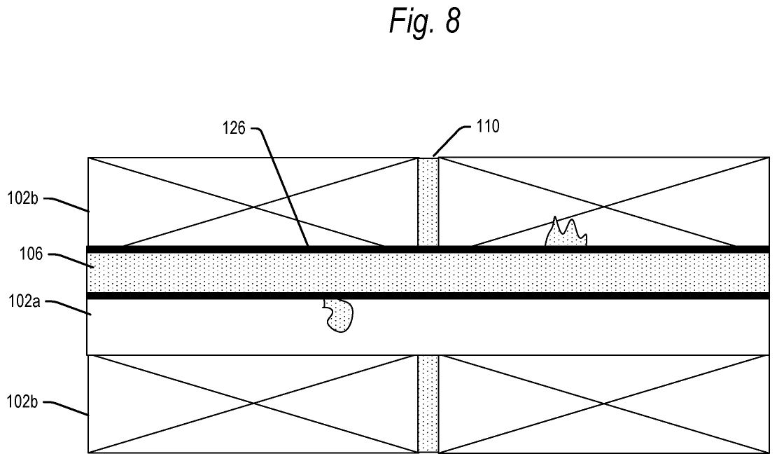

FIGS. 7-9 illustrate a second embodiment of the present technology. In this embodiment, instead of drilling two concentric holes (114, 106), a single hole (106) is drilled to the final diameter (FIG. 7). Next, as shown in FIG. 8, a viscous fluid 126 is injected along the length of the drilled holes 106. Various viscous fluids or pastes may be used for viscous fluid 126, but in embodiments, the fluid may be CI-GV adhesive from Simpson-Strong-Tie, headquartered in Pleasanton, Calif. While using an adhesive for viscous fluid 126 has advantages, the viscous fluid need not be an adhesive in further embodiments. In such embodiments, the viscous fluid 126 should not inhibit the bond between the adhesive glue 108 (described below) and the perimeter of the holes 106. The viscous fluid 126 may be more viscous than the glue adhesive used to secure the rod. However, the viscous fluid 126 need not be more viscous that the glue adhesive in further embodiments.

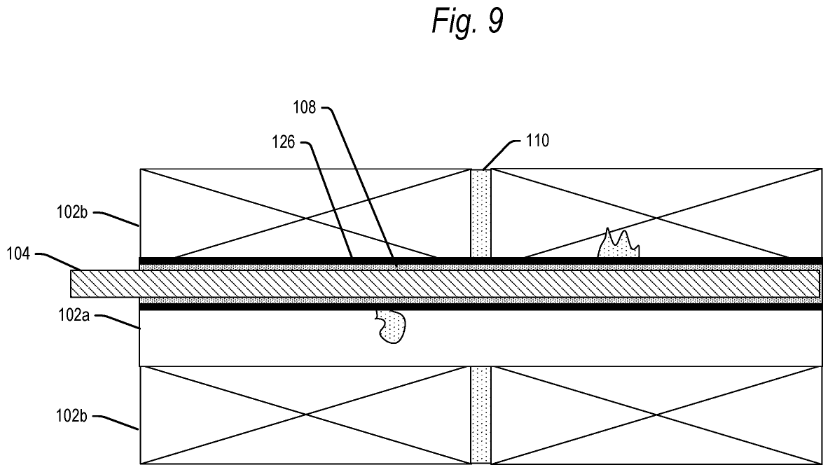

The viscous fluid 126 may be injected by any of the methods described above for expanding foam 120. The viscous fluid 126 may have a viscosity such that the fluid coats the drilled holes 106 with limited seepage into the voids 110, effectively sealing the drilled holes 106 from the voids 110. The viscous fluid may thereafter be cured or otherwise set. Next, the rods 104 with adhesive glue 108 may be inserted into holes 106 as shown in FIG. 9. The adhesive contacts the viscous fluid 126 and rod 104 along the length of holes 106 at all locations, effectively binding the rod 104 within the drilled holes 106. To facilitate filling of the space between the rod 104 and the viscous fluid 126 the adhesive 108 may be introduced into hole 106 through an air hole 124 (FIG. 1). Additional air holes 124 (not shown) may be placed at intervals along the hole 106 to allow air to escape while the adhesive 108 fills the space between the rod 104 and the viscous fluid 126.

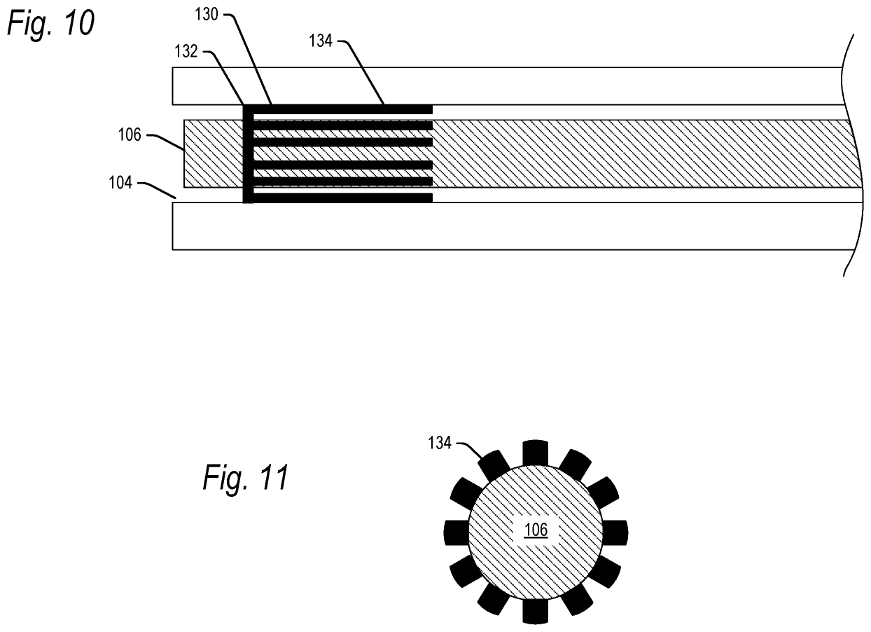

In embodiments, when inserting a rod into a drilled hole, it may be desirable to include structure ensuring that the rod is centered within the drilled hole, thus ensuring a uniform layer of adhesive all around the rod within the drilled hole. FIGS. 10-13 illustrate two structures which can be used to ensure the rod 104 is centered within the drilled hole 106 in accordance with aspects of the present technology. The structures of FIGS. 10-13 may be used with any of the above described embodiments. Moreover, as explained below, the structures of FIGS. 10-13 may be used with each other, for example one structure being placed at a first end of the rod 104 and another structure being placed at the second, opposed end of the rod.

FIGS. 10 and 11 are cross-sectional side and cross-sectional top views, respectively, of a collar 130 which fits over the rod 104 and into the hole 106. The inner diameter of the collar 130 fits snugly around the rod 104, and the outer diameter of the collar 130 fits snugly within the hole 106. In embodiments, the collar 130 may include a ring 132 and legs 134 extending from the ring, axially around the rod 104. The legs 134 may each be about ¼ inch wide and may be two inches, long, but they may be wider, narrower, longer or shorter than that in further embodiments. As seen in FIG. 11, there may be 12 legs 134 around the circumference of the rod 104, each spaced 30° from each other, but there may be greater or fewer legs in further embodiments. The ring may be formed of various hard polymers, but may alternatively be formed of other materials such as various metals or ceramics. As seen in FIG. 11, the surface of each leg 134 in contact with the rod 104 may be flat, and the surface in contact with the wood around hole 106 may be radiused.

The collar 130 may be installed on the rod 104 by slipping it over the free end of the rod and positioning it such that the top of the ring 132 is flush to the wood surface or slightly below the surface. The collar 130 may be bonded in place to the rod or the wood prior to adhesive injection. The ring 132 may have a thinner profile so as to allow adhesive to flow around the ring 132, and between legs 134. Alternatively, the collar 130 may be inserted into the hole 106 over rod 104 after adhesive is injected into the hole 104.

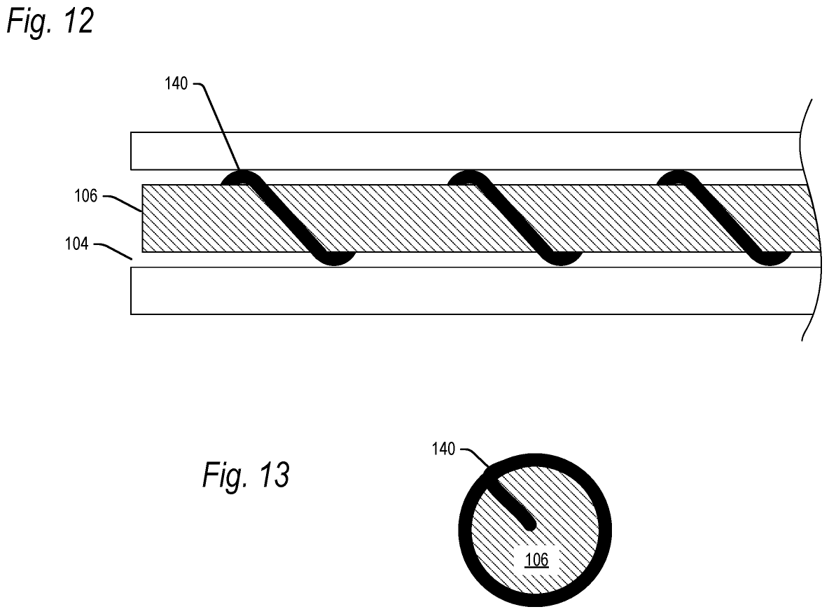

FIGS. 12 and 13 are cross-sectional side and cross-sectional top views, respectively, of a helix 140 which wraps around the rod 104 and into the hole 106. The inner diameter of the helix 140 fits snugly around the rod 104, and the outer diameter of the helix 140 fits snugly within the hole 106. The helix may be ¼ inch wide, though it may be thicker or thinner in further embodiments. As seen in FIG. 12, the helix 140 may have a pitch of approximately 1 inch, or a pitch equal to the diameter of the rod 106, though the pitch may be shorter or longer than that in further embodiments. The helix may be formed of various hard polymers, but may alternatively be formed of other materials such as various metals or ceramics. The helix may be glued or otherwise attached to the rod 106 prior to insertion of the rod 106 into hole 104. A surface of the helix 140 in contact with the rod 104 may be flat, and the surface in contact with the wood around hole 106 may be radiused. The helix 140 wraps around the rod 106 and allows the rod to be rotated as it is inserted into the hole 104. Adhesive may flow along a length of the helix 140.

In one embodiment, the collar 130 and helix 140 may be used together, with the collar 130 positioned at a top of the rod 106, and the helix positioned at a bottom of the rod 106. However, various combinations of collars 130 and lengths of the helix 140 may be used.

As used herein, a connection may be a direct connection or an indirect connection (e.g., via one or more other parts). In some cases, when an element is referred to as being affixed, connected or mounted to another element, the element may be directly connected to the other element or indirectly connected to the other element via intervening elements. When a first element is referred to as being directly affixed, directly connected or directly mounted to a second element, then there are no intervening elements between the first and second elements.

In summary, the present technology relates to a glued-in-rod structure configured to receive a rod, comprising: a piece of wood, the piece of wood comprising one or more voids; and a prepared hole, the prepared hole comprising: a central axis, a foam injected into the prepared hole, the foam at least partially filling at least one void of the one or more voids that is open to the prepared hole, and a final hole concentric with the central axis, the final hole having a diameter configured to receive the rod.

In a further example, the present technology relates to a glued-in-rod structure configured to receive a rod, comprising: a piece of wood, the piece of wood comprising one or more voids; and a prepared hole, the prepared hole comprising: a central axis, a viscous fluid coating the prepared hole and at least partially filling at least one void of the one or more voids that is open to the prepared hole, and an adhesive at least partially filling the prepared hole, the viscous fluid preventing the adhesive from leaking into the at least one void.

In another embodiment, the present technology relates to a method of preparing a hole to receive a rod in a glued-in-rod structure, the glued-in-rod structure comprising one or more voids, the method comprising: a) drilling an intermediate hole within the glued-in-rod structure, the intermediate hole open to at least one void of the one or more voids; b) injecting a foam into the intermediate hole, the foam at least partially filling the at least one void and hardening; and c) drilling a final hole, the drilled final hole leaving portions of the foam in the at least one void to seal the at least one void off from the final hole.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A glued-in-rod structure configured to receive a rod, comprising:
a piece of wood, the piece of wood comprising one or more voids; and
a prepared hole, the prepared hole comprising:
a central axis,
a foam injected into the prepared hole, the foam at least partially filling at least one void of the one or more voids that is open to the prepared hole, and
a final hole concentric with the central axis, the final hole having a diameter configured to receive the rod.

2. The glued-in-rod structure of claim 1, wherein sidewalls of the final hole are portions of the piece of wood and the foam in the at least one void.

3. The glued-in-rod structure of claim 1, further comprising an adhesive at least partially filling the final hole, the foam preventing the adhesive from leaking into the at least one void.

4. The glued-in-rod structure of claim 1, wherein the foam is an expanding foam.

5. The glued-in-rod structure of claim 1, wherein the foam hardens into a solid after injection into the prepared hole and at least one void.

6. The glued-in-rod structure of claim 1, wherein the final hole is a drilled hole.

7. The glued-in-rod structure of claim 1, wherein the final hole enlarges a diameter of the prepared hole as compared to a diameter of the prepared hole when the foam was injected.

8. The glued-in-rod structure of claim 1, further comprising a collar within the final hole configured to center the rod within the final hole.

9. The glued-in-rod structure of claim 1, further comprising a helix within the final hole configured to center the rod within the final hole.

10. A glued-in-rod structure configured to receive a rod, comprising:
a piece of wood, the piece of wood comprising one or more voids; and
a prepared hole, the prepared hole comprising:
a central axis,
a viscous fluid coating the prepared hole and at least partially filling at least one void of the one or more voids that is open to the prepared hole, and
an adhesive at least partially filling the prepared hole, the viscous fluid preventing the adhesive from leaking into the at least one void.

11. The glued-in-rod structure of claim 10, wherein sidewalls of the final hole are defined by the viscous fluid.

12. The glued-in-rod structure of claim 10, wherein the final hole is a drilled hole.

13. The glued-in-rod structure of claim 10, further comprising a collar within the final hole configured to center the rod within the final hole.

14. The glued-in-rod structure of claim 10, further comprising a helix within the final hole configured to center the rod within the final hole.

15. A method of preparing a hole to receive a rod in a glued-in-rod structure, the glued-in-rod structure comprising one or more voids, the method comprising:
a) drilling an intermediate hole within the glued-in-rod structure, the intermediate hole open to at least one void of the one or more voids;
b) injecting a foam into the intermediate hole, the foam at least partially filling the at least one void and hardening; and
c) drilling a final hole, the drilled final hole leaving portions of the foam in the at least one void to seal the at least one void off from the final hole.

16. The method of preparing a hole to receive a rod in a glued-in-rod structure as recited in claim 15, wherein said step c) comprises enlarging the intermediate hole drilled in said step a).

17. The method of preparing a hole to receive a rod in a glued-in-rod structure as recited in claim 15, wherein said step c) comprises drilling a hole that is concentric with the intermediate hole drilled in said step a).

18. The method of preparing a hole to receive a rod in a glued-in-rod structure as recited in claim 15, further comprising the step of at least partially filling the final hole with an adhesive.

19. The method of preparing a hole to receive a rod in a glued-in-rod structure as recited in claim 15, further comprising the step of inserting a collar within the final hole configured to center the rod within the final hole.

20. The method of preparing a hole to receive a rod in a glued-in-rod structure as recited in claim 15, further comprising the step of inserting a helix within the final hole configured to center the rod within the final hole.
